(19) United States
(12) Patent Application Publication
(10) Pub. No.: US 2024/0010288 A1
(43) Pub. Date: Jan. 11, 2024

(54) Bicycle Storage Compartment

(71) Applicant: Canyon Bicycles GmbH, Koblenz (DE)

(72) Inventor: Lorenz Lay, Koblenz (DE)

(21) Appl. No.: 18/217,680

(22) Filed: Jul. 3, 2023

(30) Foreign Application Priority Data
Jul. 5, 2022 (DE) 20 2022 103 752.3

(51) Int. Cl. B62J 9/22

(52) U.S. Cl. CPC B62J 9/22

(57) ABSTRACT

A bicycle storage compartment includes a storage compartment arranged inside a bicycle frame tube, in particular a down tube of a bicycle frame. The storage compartment is closed by a cover element. With the aid of a fixing element, the cover element is releasably fixed to the bicycle frame tube. For simple and reliable operation and fixation, the fixing element includes a lever element fastened to the bicycle frame tube or the cover element and cooperating with a lug provided on the cover element or the bicycle frame tube.

### CROSS-REFERENCE TO RELATED APPLICATION

This application claims priority to German Patent Application No. 20 2022 103 752.3 filed Jul. 5, 2022, the disclosure of which is hereby incorporated by reference in its entirety.

### BACKGROUND OF THE INVENTION

### Field of the Invention

The invention relates to a bicycle storage compartment.

### Description of Related Art

For the storage of items such as bicycle tools, tubes, spare parts, rain jackets and the like, it is known to arrange bicycle storage compartments in the down tube of a bicycle frame in addition to saddle bags and other bags to be attached to the bicycle. These bicycle storage compartments can be closed with a cover element.

### SUMMARY OF THE INVENTION

An object of the invention is to provide a bicycle storage compartment whose cover element can be closed in a simple and reliable manner.

According to the invention, the object is achieved by a bicycle storage compartment having the features as described herein.

The bicycle storage compartment according to the invention comprises a storage compartment arranged inside a bicycle frame tube. The bicycle frame tube is in particular a down tube or a saddle tube of a bicycle frame. The bicycle storage compartment comprises a cover element for closing the storage compartment. Furthermore, a fixing element is provided for releasably fixing the cover element to the bicycle frame tube. According to the invention, the fixing element comprises a lever element fastened to the bicycle frame tube or the cover element, wherein several lever elements may also be provided. The at least one lever element cooperates with a lug provided on the cover element or the bicycle frame tube. Closing the storage compartment by the cover element is thus effected according to the invention by actuation of a lever element. Such a lever element can ensure secure and reliable closing and firm fixing of the cover element to the bicycle frame tube. In particular, for example, detachment of the cover element is avoided even when driving over very rough ground. Furthermore, providing a lever element has the advantage that it can be configured in such a way that a high and reliable retaining force is ensured with a relatively low required closing force. In particular, for example, rattling of the cover element is also avoided. In particular, the lever element can be designed as a draw latch device, wherein it is preferred that the lever element, in particular the lever element with the lug, is a draw latch.

Preferably, the lever element is firmly fastened to the bicycle frame or the cover element via a base element. In particular, the lever element is fastened in such a way that, on the one hand, it is movably fastened to the base element, but on the other hand, a permanent fastening is realized via the base element, so that the lever element is not a separate element that possibly could also be lost.

Preferably, the lever element is firmly fastened to the bicycle frame or the cover element via a deflection lever. Preferably, the lever element is fastened to the base element via the deflection lever, so that the deflection lever is fastened between the lever element and the base element. Here it is also preferred that a movable but permanent fastening is provided. By providing a deflection lever, it is particularly possible to apply reliable closing forces with low required operating forces.

Preferably, the lever element is pivotably connected to a main axis. In particular, the main axis is connected to the lever element in a region, so that the free end of the lever element is longer than the end of the lever element that cooperates with the lug. This allows correspondingly high retaining forces to be realized with low operating forces. It is particularly preferred that a deflection lever is additionally provided and that the deflection lever is also pivotably connected to the main pivot axis. Thus, in a particularly preferred embodiment, the main pivot axis is a common axis about which both the lever element and the deflection lever can be pivoted. It is also particularly preferred that the deflection lever can be pivoted via an additional axis. The additional axis can be directly connected to the bicycle frame tube or to the cover element, wherein it is particularly preferred that the additional axis is connected to the base element. Such a configuration of the lever element in combination with a deflection element and two axes can realize a lever mechanism that is easy and reliable to handle.

In a particularly preferred further development of the invention, the main axis is arranged parallel to the additional axis. Irrespective of the arrangement of the additional axis to the main axis, in particular in the case of a parallel arrangement of the two axes, they are preferably arranged in such a way that in the closed state of the fixing element, i.e. with the storage compartment closed by the cover element, the fixing element remains closed by self-locking. This is realized in particular by the fact that the lever element is moved over a bottom dead center when closing. The lever element in conjunction with the deflection element thus functions according to the toggle lever principle. To ensure secure closing and reliable self-locking in the closed state, it is particularly preferred that a counterforce is generated. The counterforce can be provided by plastic elements which, when the lever element is thrown, are compressed until the dead center is reached and then start to expand again slightly. Thus, a counterforce is generated. It is particularly preferred to cause this counterforce by means of a seal. Here, a corresponding elastic sealing element is arranged on an inner side of the cover element or between the cover element and the bicycle frame and is compressed when the fixing element is closed by throwing the lever element.

Furthermore, it is preferred that the fixing element is arranged on a side wall of the bicycle frame tube. This makes it possible to arrange the cover element in particular on an upper side of the bicycle frame tube so that the storage compartment is easily accessible.

For ease of operation and handling, it is further preferred that the main axis and/or the additional axis extend substantially in the longitudinal direction of the bicycle frame tube.

Depending on the configuration, the lug cooperating with the lever element is arranged on the cover element or on the bicycle frame tube. In a particularly preferred embodiment, a longitudinal axis of the lug is parallel to the main axis. For example, if several lugs are provided, a connection line of the lugs is parallel to the main axis. Several lever elements, in particular arranged parallel to each other, can also be provided which cooperate with a common lug, wherein a separate lug may also be provided for each lever element.

Furthermore, it is preferred that the cover element has a retaining element on a side opposite the fixing element. This may be a hinge by which the cover element is connected to the bicycle frame tube. Furthermore, instead of a retaining element, a corresponding lever element can be arranged on the opposite side as described above. This may then comprise a deflection lever, a base element and the like as described above.

In a preferred embodiment, the retaining element comprises a groove in which a projection engages. The cover element is thus inserted into the retaining element. Here, it is particularly preferred that the cover element itself comprises the groove, and the projection is formed by the bicycle frame tube.

In another particularly preferred further development, it is possible to connect an additional element, such as a water bottle holder, to the cover element. A water bottle holder can also be integrally formed with the cover element. For connecting an additional element such as a water bottle holder, it is preferred that the cover element has at least one thickening for receiving at least one holder. The holders can be threaded inserts, for example, to which an additional element such as a water bottle holder can be attached. The at least one thickening is preferably arranged on an inner side of the cover element facing toward the storage compartment. In particular, the thickening is a bead extending in the longitudinal direction of the bicycle frame tube in the mounted state. It is preferred that the thickening, preferably in the form of a bead, extends partially or substantially completely over the length of the cover element extending in the longitudinal direction of the bicycle frame tube.

### BRIEF DESCRIPTION OF THE DRAWINGS

In the following, the invention is described in more detail by means of a preferred embodiment with reference to the accompanying drawings.

In the drawings:

FIG. 1 is a sectional view of the bicycle storage compartment in a closed state,

FIGS. 2 to 4 are a sectional view corresponding to FIG. 1, wherein the lever element is shown in different opening states, and

FIG. 5 is a sectional view corresponding to FIG. 1 with an opened fixing element.

### DESCRIPTION OF THE INVENTION

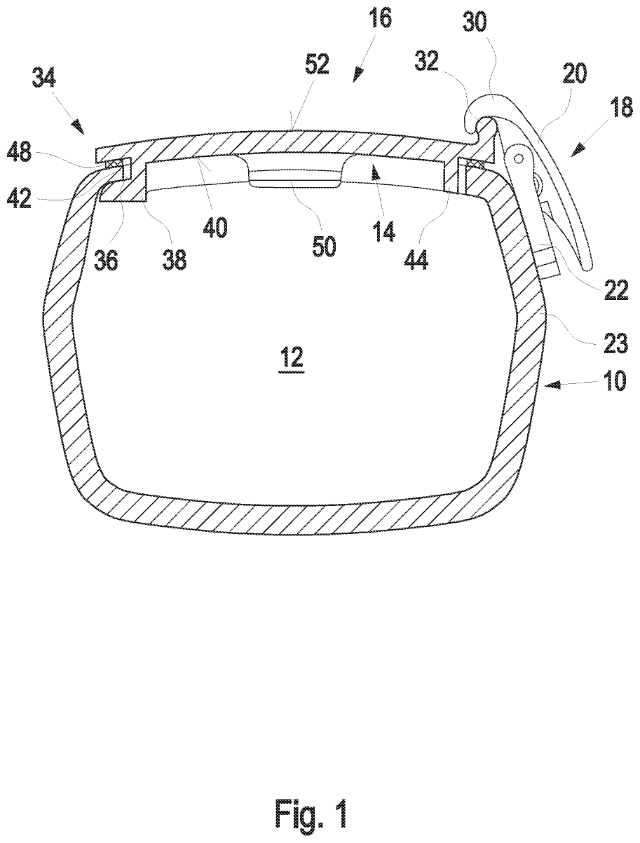

A bicycle frame tube 10, which is in particular a down tube of a bicycle frame, has an interior 12 which is configured as a storage compartment. For this purpose, an additional element forming the storage compartment can be provided in the interior 12, the additional element having, for example, additional pockets, fixing elements, retaining straps and the like. The storage compartment 12 is accessible through an opening 14 disposed in the bicycle frame tube 10, wherein the opening 14 is provided on an upper side of the bicycle frame tube in the illustrated exemplary embodiment. The opening 14 can be closed by a cover element 16. Closing is effected by means of a fixing element 18 cooperating with the cover element 16 and the bicycle frame tube 10. In the illustrated exemplary embodiment, said fixing element is arranged on the right-hand side of the bicycle frame tube 10 in FIG. 1, wherein a corresponding fixing element can also be provided on the left-hand side in a mirror-inverted manner.

The fixing element 18 comprises a lever element 20, which in the illustrated exemplary embodiment is indirectly connected to the bicycle frame tube 10, in particular to a side wall 23 of the bicycle frame tube 10, via a base element 22 and a deflection lever 24.

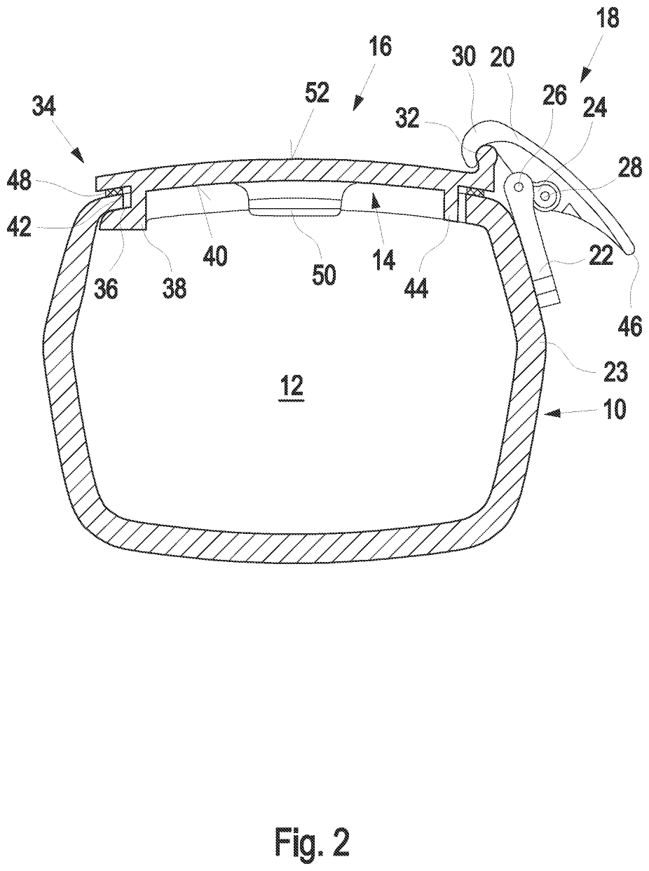

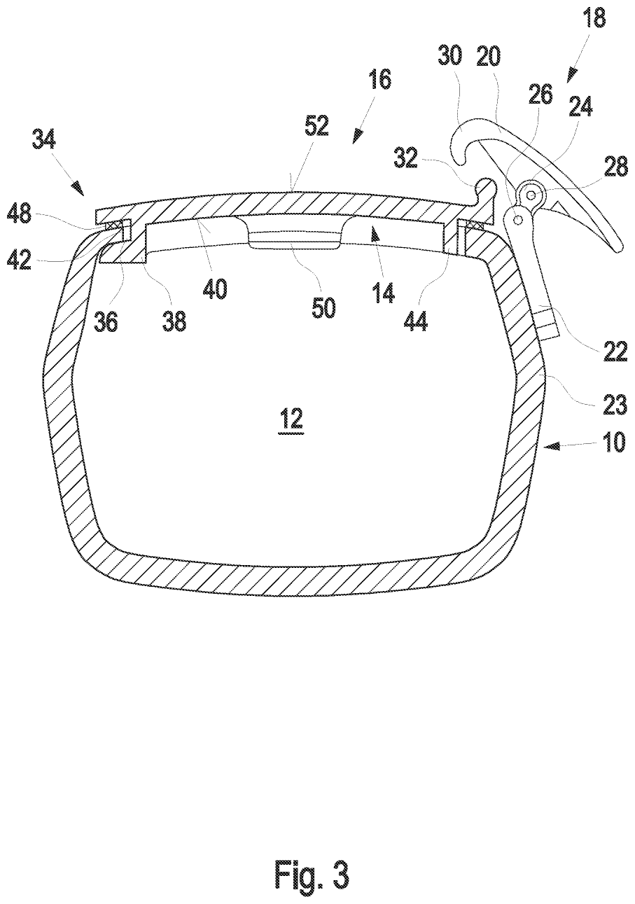

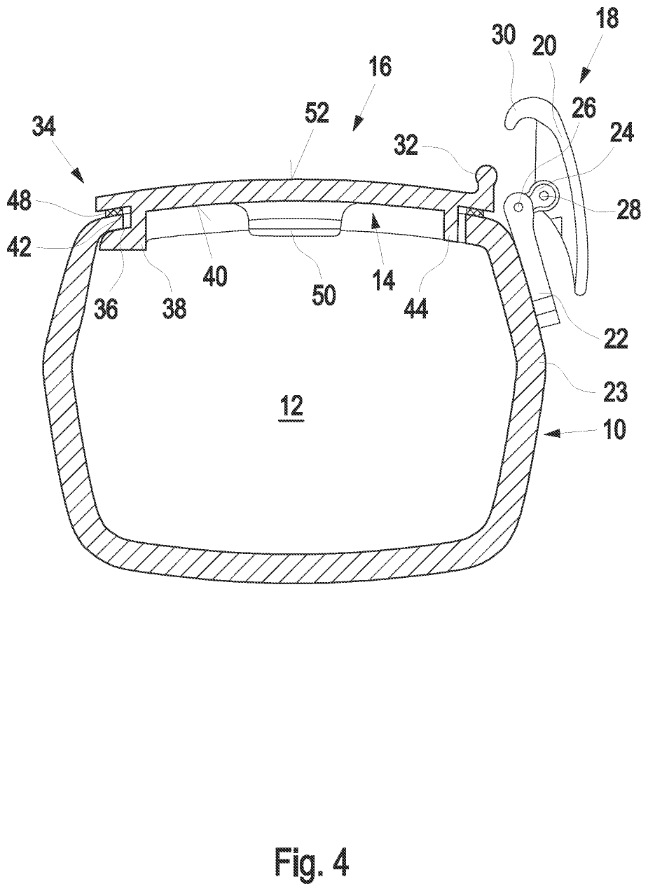

The base element 22 is fixedly connected to or integrally formed with the bicycle frame tube. The deflection lever 24 is connected to the base element 22 via an additional axis 26. The deflection lever 24 is in turn pivotably connected to the lever element 20 via a main axis 28. The lever element 20 can thus be pivoted as shown in particular in FIGS. 2, 3 and 4.

A head portion 30 of the lever element 20 cooperates with a lug 32 provided on the cover element 16. Here, the head portion 30 may have a concavely curved inner side that cooperates with a convexly curved outer side of the lug 32. Several lugs 32 may be provided on the cover element 16 in the longitudinal direction of the bicycle frame tube, i.e. perpendicular to the drawing plane, or one lug 32 may be provided extending substantially over the entire side length of the cover element 16. Similarly, several fixing elements 18 may be provided one behind the other perpendicular to the drawing plane in the longitudinal direction of the bicycle frame tube 10, or a lever element may be provided extending substantially over the entire length of the cover element 16. In the longitudinal direction of the bicycle frame tube 10, the cover element preferably extends over a length of 10 cm to 20 cm.

A retaining element 34 is arranged on the side of the cover element 16 opposite the fixing element 18. In the illustrated exemplary embodiment, the retaining element 34 has a groove 36 disposed in the cover element and extending in longitudinal direction perpendicular to the drawing plane. For example, the groove 36 is formed by an L-shaped lug 38 in cross-section formed on an inner side 40 of the cover element 16. To fix the cover element 16 on the left-hand side in FIG. 1, the cover element is arranged in such a way that a projection 42 formed by the bicycle frame tube 10 engages in the groove 36.

A guiding lug 44 is provided on the inner side 40 of the cover element 16 on the side opposite the L-shaped lug 38. A corresponding guiding lug 44 may also be arranged on the front and rear sides of the cover element 16 provided in longitudinal direction, so that a circumferential guiding element is implemented for adjusting the cover element 16 in the opening 14 of the bicycle frame tube 10.

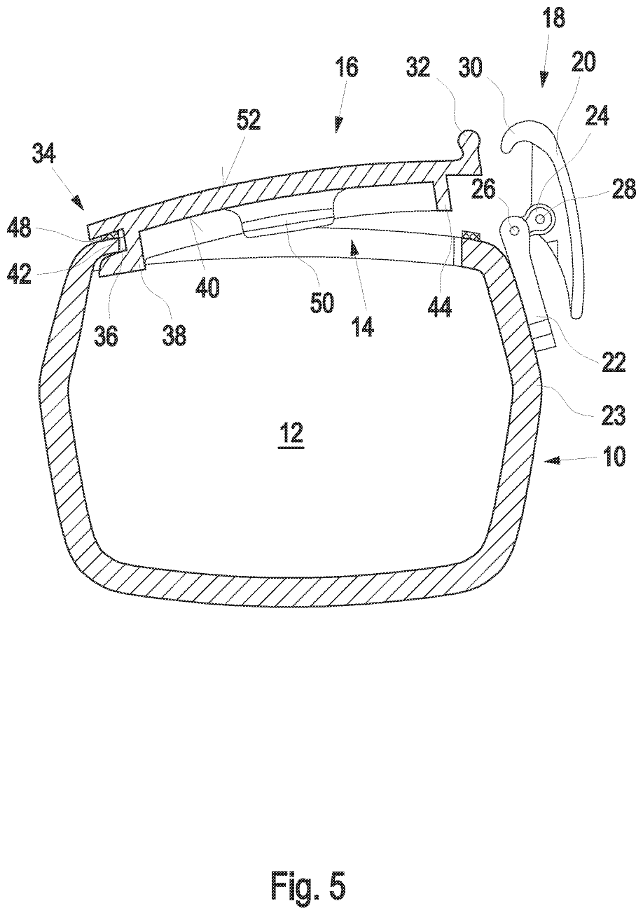

From the closed position shown in FIG. 1, to open the cover element 16, the lever 20 is pivoted about the main axis 28 and the deflection lever 24 is pivoted about the additional axis 26, as shown in FIGS. 2, 3 and 4. The cover element 16 can then be removed to expose the opening 14, as shown in FIG. 5.

For closing, the cover element 16 is inserted into the opening 14 and then the lever element 10 is pivoted into the position shown in FIG. 2 so that the head portion 30 of the lever element 20 rests against the lug 32. Then, a free end 46 of the lever element 20 is moved toward the base element 22. In doing so, a seal 48 disposed between the cover element 16 and the bicycle frame tube is compressed until the lever 20 reaches a bottom dead center. The bottom dead center is reached shortly before the lever element 20 pivots completely toward the base element 22. Further pivoting causes the dead center to be passed in accordance with a toggle lever mechanism, wherein the compressed seal 48 is again slightly decompressed. Due to the remaining residual compressions of the seal 48, a counterforce is generated that ensures secure closing and fixing of the lever element 20 in the closed position.

A bead-shaped thickening 50 is provided on the inner side 40 of the cover element 16 in the illustrated preferred embodiment. In particular, the thickening 50 extends partially in the longitudinal direction of the cover element 16 or substantially along the entire longitudinal direction of the cover element 16. By providing the thickening it is possible to provide a retaining element such as a threaded sleeve open at an outer side 52 of the cover element 16 in this area of the cover element. In particular, by providing two threaded sleeves at a distance, it is possible to arrange a bottle holder or the like on the outer side 52 of the cover element 16.

1. A bicycle storage compartment comprising:
a storage compartment arranged inside a bicycle frame tube, in particular a down tube,
a cover element closing the storage compartment, and
a fixing element for releasably fixing the cover element to the bicycle frame tube,
wherein,
the fixing element comprises a lever element fastened to the bicycle frame tube or the cover element and cooperating with a lug provided on the cover element or the bicycle frame tube.

2. The bicycle storage compartment according to claim 1, wherein the lever element is fastened via a base element firmly fastened to the bicycle frame tube or the cover element.

3. The bicycle storage compartment according to claim 1, wherein the lever element is fastened via a deflection lever to the bicycle frame tube or to the cover element, preferably to the base element.

4. The bicycle storage compartment according to claim 1, wherein the lever element is pivotable about a main axis.

5. The bicycle storage compartment according to claim 3, wherein the deflection lever is pivotable about the main axis.

6. The bicycle storage compartment according to claim 3, wherein the deflection lever is pivotably connected to the base element via an additional axis.

7. The bicycle storage compartment according to claim 6, wherein the additional axis is parallel to the main axis.

8. The bicycle storage compartment according to claim 6, wherein the additional axis and the main axis are arranged in such a way that the fixing element remains closed by self-locking in the closed state.

9. The bicycle storage compartment according to claim 1, wherein the fixing element, in particular the base element of the fixing element, is arranged on a side wall of the bicycle frame tube.

10. The bicycle storage compartment according to claim 4, wherein the main axis and/or the additional axis extend substantially in the longitudinal direction of the bicycle frame tube.

11. The bicycle storage compartment according to claim 1, wherein the lug extends parallel to the main axis.

12. The bicycle storage compartment according to claim 1, wherein the cover element comprises a retaining element on a side opposite the fixing element.

13. The bicycle storage compartment according to claim 12, wherein the retaining element comprises a groove which a projection engages, wherein the groove preferably disposed in the cover element and the projection is formed by the bicycle frame tube.

14. The bicycle storage compartment according to claim 1, wherein an in particular circumferential seal is provided on an inner side of the cover element facing toward the bicycle frame tube.

15. The bicycle storage compartment according to claim 1, wherein the cover element comprises at least one thickening for receiving at least one holder.

16. The bicycle storage compartment according to claim 15, wherein the thickening is formed on the inner side of the cover element, in particular in the form of a bead.
